(19) United States
(12) Patent Application Publication
(10) Pub. No.: US 2016/0055538 A1
(43) Pub. Date: Feb. 25, 2016

(54) WIRELESS BEACONS FOR REPORTING OF APPLICATIONS IN THE FOREGROUND OF A USER DEVICE INTERFACE

(71) Applicant: EBAY INC., San Jose, CA (US)

(72) Inventor: Michael Charles Todasco, San Jose, CA (US)

(21) Appl. No.: 14/467,440

(22) Filed: Aug. 25, 2014

(51) Int. Cl. G06Q 30/02

(52) U.S. Cl. CPC G06Q 30/0269; G06Q 30/0261; G06Q 30/0267

(57) ABSTRACT

There are provided systems and methods for wireless beacons for reporting of applications in the foreground of a user device interface. A user may bring a user device to a merchant location and utilize the user device while shopping at the merchant location, for example, to do comparative shopping and read item reviews. The merchant location may include wireless beacons at or nearby an area where items the user is viewing are sold. The beacon may provide communication services with the user devices for the user. Using the beacon, the merchant or a service provider may receive information about the applications executing in the foreground of a user device. Thus, if the user is utilizing a browser or marketplace application to perform some price matching, additional incentives may be provided to the user so the merchant retains the user as a customer.

### TECHNICAL FIELD

The present application generally relates to wireless beacons for reporting of applications in the foreground of a user device interface and more specifically to utilizing wireless beacons to report what applications a user may be utilizing on a user device while at a merchant location in order to present the user with information corresponding to the merchant location or items available at the merchant information.

### BACKGROUND

Users may bring mobile user devices with them to merchant locations in order to utilize various mobile applications while at the merchant location. The user device applications may assist the user by providing browser features, item entry and lookup processes, and/or mapping procedures. The user may utilize the applications to perform price matching at the merchant location as well as read reviews for products and find the same or similar items available from other merchants, such as a nearby merchant selling the item at a cheaper price. While these applications provide various benefits to the user, the merchant for the merchant location may not receive similar benefits. For example, the merchant may lose business due to comparative shopping even before the merchant even has a possibility to offer reduced prices to the user or offer other benefits that may retain the user as a customer. Thus, the merchant may wish to provide incentives to users if the users utilize mobile devices while shopping for items. In other times, the merchant may wish to match prices of competitors that the merchant knows the user may utilize for comparative pricing.

### BRIEF DESCRIPTION OF THE DRAWINGS

FIG. 1 is a block diagram of a networked system suitable for implementing the processes described herein, according to an embodiment;

FIG. 2 is an exemplary environment displaying a wireless beacon reporting applications executing the in foreground of user devices for users at a merchant location, according to an embodiment;

FIG. 3 is an exemplary system environment showing a user interface of a user device and a merchant device after receiving information of application executing on a user device from a wireless beacon, according to an embodiment;

FIG. 4 is a flowchart of an exemplary process for wireless beacons for reporting of applications in the foreground of a user device interface, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide wireless beacons for reporting of applications in the foreground of a user device interface. Systems suitable for practicing methods of the present disclosure are also provided.

Various merchant locations may provide short range wireless communications with a user device, such as through beacons using Bluetooth Low Energy (BLE), LTE Direct, or other communication protocol. These beacons may be set up at a merchant location, such as at or nearby various sub-areas within the merchant location where the user may shop for items. The beacons may communicate with devices in possession of users to alert the users of check-in services offered through their device. The beacons may provide additional functionality, such as establishing a connection with a merchant device or server to complete transactions and/or transmit information received from the user device to the merchant device/service. Thus, the beacons may communicate with the users' devices directly, including information stored in the beacons and/or provide communication with a device attached to, or in communication with, the beacon, such as the device/server of the merchant.

A merchant may have a merchant location where a user, such as a consumer, may visit to view and purchase items or services. The merchant may offer check-in services through one or more short range wireless beacons established at and throughout the merchant location. When a user brings a user device to the merchant location, the beacons may communicate with the user device. These beacons at the merchant location may utilize short range wireless communications to communicate with the user device in possession of the user. The beacons may employ Bluetooth Low Energy (BLE), LTE Direct, or another communication protocol to emit a communication signal receivable by the user device. The communication may include an identifier for the beacon, the user, the merchant, and/or a payment or service provider administering the beacons.

The user device may be set up to passively monitor for BLE communications. When the device detects the signal and verifies the one or more identifiers, both the device and the beacon may ramp up in power and establish a connection, where the connection may further enable the device to communicate with the merchant and/or a payment provider offering payment services between the merchant and the user or other service provider. The beacon may be connected to a networked device at the merchant location, or the beacon may include network functionality to communicate with other devices and/or servers, such as a server for the merchant or service provider. Thus, the beacon enables the user device to establish a connection, communicate check-in information (e.g., an identifier for the user), and/or complete a check-in with the merchant location. The check-in may be completed automatically when the user device is in range of the beacon, or may be completed after prompting the user to check-in when the user device is in range of the beacon.

Once the merchant has established at least one wireless beacon at the merchant location, the wireless beacon(s) may connect to the user device when the user device is in proximity to the wireless beacon(s). For example, a wireless beacon may broadcast an identifier, which, when received, may initiate a check-in for a user device within an area around the wireless beacon. Thus, as the user device enters that area, the user device may connect to the wireless beacon and/or initiate the connection and check-in process. The wireless beacon(s) may be range limited to correspond to a sub-area or location within the merchant location, such as by limiting the signal strength of the beacon and/or utilizing the physical boundaries of the merchant location

Once the user device connects to the beacon, various information about the user device may be accessed, received, and/or retrieved by the wireless beacon. For example, once the user device connects to the beacon, information about an application executing in the foreground of an operating system of the user device may be received by the wireless beacon. Thus, if a browser, item lookup, merchant sales, marketplace, or other application is executing in the foreground of the device interface, for example, when a user is utilizing the application, the wireless beacon may receive information about such an application. The wireless beacon may communicate such information to a merchant device or a service provider server for processing. The application information may include an application name, type, or other identification information for the application. The application information may further include information about user behavior in the application, such as actions the user takes with respect to the application (e.g., webpage navigations, user input, item lookups, and/or item input such as scans or images of items) and time spent on the application. For example, the amount of time spent in the application may indicate that a user is more likely performing comparative shopping and/or purchasing an item with another merchant. The user may set what information is transmitted to the wireless beacon using security settings of the user device. Moreover, the merchant or service provider may determine what information is retrieved by the wireless beacon.

Once the merchant/service provider receives the application information, the application information may be processed to determine an incentive, information, sale price, and/or assistance to provide to the user. For example, the application information may show that the user is browsing a competitor's pricing. The application information may be utilized to determine an interest or parameter for the user, such as a type of item or service the user may be interested in purchasing. The application information may include the interest for the user, or the interest may be determined based on the type of application the user is utilizing (e.g., a price matching application within an electronics store). In various embodiments, the wireless beacon may be established at a sub-area within the area location where a specific item or item type is sold (e.g., televisions, computers, etc.). In such embodiments, the merchant may be aware that the user is performing price matching, viewing competitors, etc., for the items available at the sub-area. Thus, the interest may further be determined using the location of the wireless beacon within the merchant location.

Thus, the merchant may provide an overall discount to the user based on the fact the user is browsing a competitor's website or utilizing a competitors application, or may send a store employee to the user's location to assist the user. The incentive provided to the user may also be specific to the item or type of item the user is purchasing, such as a 20% discount for an item type, or a no interest or down payment credit extension for item types. Where a service provider receives information about the interest/parameter of the user while the user is at the merchant location, the service provider may provide the user with nearby merchants that sell items/services related to the interest/parameter of the user. The merchant may also utilize information about how often a user performs price matching with competitors to dictate pricing of the merchant location. For example, if in a section of a merchant location where a user is 50% likely to perform price matching for available items, the merchant may utilize information about competitors pricing to determine prices and benefits for the available items. However, if users do not open applications to perform price matching in another area of the merchant location, the merchant may be less concerned with maintaining competitive prices for items available in that area.

In various embodiments, the merchant may access and/or receive additional information about the user to ensure the user does not trick the merchant into providing discounts where the user is not likely to purchase with another merchant. For example, common merchants for the user may be determined. Thus, if the merchant receives information that the user is utilizing an application for a merchant that the user rarely shops with, the merchant may be less inclined to provide a discount for an item offered by the other merchant. In other embodiments, if the merchant knows that the other merchant is currently out of stock or does not offer decent sales for an item, the merchant may not offer discounts for the item. Thus, profitability for the merchant may also be tied to discounts and/or price matching, for example, low inventory levels and/or low margins of profit may also be utilized to determine if an item receives a discount.

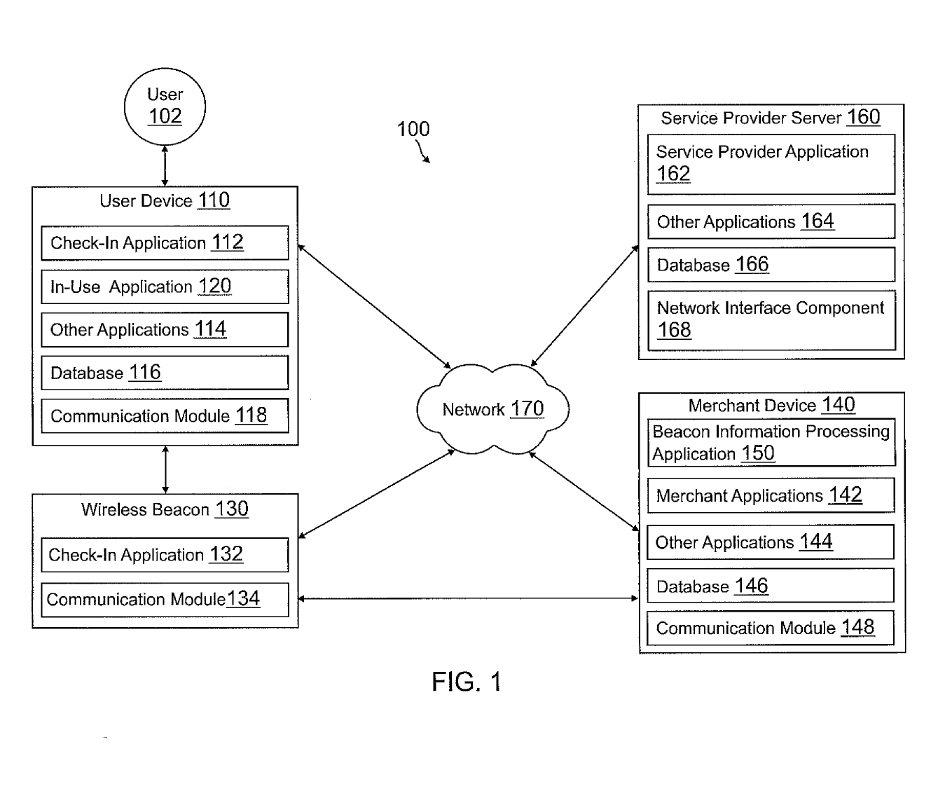

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a wireless beacon 130, a merchant device 140, and service provider server 160 in communication over a network 170. User 102, such as a consumer, may visit a merchant location corresponding to wireless beacon 130 and merchant device 140 with user device 110. User device 110 may connect to wireless beacon 130 and transmit information about an application executing in the foreground of user device 110's interface. User device 110 may utilize service provider server 160 with the application, such as to browse items available in a marketplace or perform item lookups. Merchant device 140 may receive such information and determine interests or parameters for user 102 for use in providing information and/or incentives to user 102.

User device 110, wireless beacon 130, merchant device 140, and service provider server 160 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 170.

User device 110 may be implemented using any appropriate hardware and software configured for wired and/or wireless communication with wireless beacon 130, merchant device 140, and/or service provider server 160. For example, in one embodiment, user device 110 may be implemented as a personal computer (PC), a smart phone, laptop computer, wristwatch with appropriate computer hardware resources, eyeglasses with appropriate computer hardware (e.g. GOOGLE GLASS®), or other wearable computing device, a computing device mounted within a vehicle (e.g., a console or heads up display computing device in a vehicle), and/or other types of computing devices capable of transmitting and/or receiving data, such as an IPAD® from APPLE®. Although a user device is shown, the user device may be managed or controlled by any suitable processing device. Although only one user device is shown, a plurality of user devices may function similarly.

User device 110 of FIG. 1 contains a check-in application 112, an in-use application 120, other applications 114, a database 116, and a communication module 118. Check-in application 112, in-use application 120, and other applications 114 may correspond to processes, procedures, and/or applications, for example, a software program, executable by a hardware processor. In other embodiments, user device 110 may include additional or different software as required.

Check-in application 112 may be used by user 102 of user device 110 to establish a connection with wireless beacon 130, including a cheek-in with a merchant location for wireless beacon 130/merchant device 140. Check-in application 112 may correspond to a specific application utilized by user device 110 with wireless beacon 130 and/or merchant device 140 to complete a check-in. The check-in may correspond to a process to log in to a user account of user 102 with merchant device 140 (or service provider server 160 if service provider server 160 provides check-in services for the merchant location). In other embodiments, the check-in may provide and/or verify the identity of user 102, including transmission of an identifier for user 102 and/or user device 110. The check-in may be completed over network 170 with merchant device 140 and/or service provider server 160. In such embodiments, check-in application 112 may correspond more generally to a browser application configured to communicate with merchant device 140 over a network connection (e.g., over a connection with network 170).

In various embodiments, check-in application 112 may also receive short range wireless communications from wireless beacon 130 at a location and transmit information to wireless beacon 130, including check-in information for a check-in process with the merchant location for merchant device 140 (or service provider server 160 if service provider server 160 provides check-in services for the merchant location) that associates user 102 with wireless beacon 130. For example, wireless beacon 130 may be located at the merchant location and set up to communicate with user device 110 when user device 110 is in proximity to wireless beacon 130. Wireless beacon 130 may also correspond to a sub-location/area of the merchant location, such as an area of the merchant location where a specific item/service or type of item/service is sold. Thus, wireless beacon 130 may be range limited to connect only with devices (e.g., user device 110) within the specified area, such as a radius around wireless beacon 130, a distance away from wireless beacon 130, and/or a signal direction for wireless beacon 130. Merchant device 140 may determine that user 102 is located in proximity to wireless beacon 130 using the connection.

Check-in application 112 may execute in the background of an operating system of user device 110 and be configured to establish connections, using communication module 118 of user device 110, with wireless beacon 130. The connection may be established with or without user input from user 102. For example, wireless beacon 130 may broadcast a token, such as a universally unique identifier (UUID), for reception by check-in application 112, as will be explained in more detail herein. Check-in application 112 may utilize communication module 118 of user device 110 to receive the token from wireless beacon 130. If check-in application 112 acknowledges the UUID as identifying wireless beacon 130, merchant device 140, and/or service provider server 160 (e.g., if check-in application 112 determines the UUID corresponds to a request to establish a communication channel and/or process and complete a check-in), check-in application 112 may transmit an identifier corresponding to user 102 and/or user device 110 back to wireless beacon 130. Check-in application 112 may utilize communication module 118 of user device 110 to communicate with wireless beacon 130 (e.g., over near field communication, Bluetooth, Bluetooth Low Energy, radio, infrared, LTE Direct, or other communication protocol). The identifier from user device 110 may include, be transmitted with, concatenated with, or otherwise bundled with the identifier received from wireless beacon 130. In other embodiments, different information may be transmitted to wireless beacon 130, such as an identifier for user 102, a name or other personal information for user 102, or other identifying information. Thus, the information transmitted to wireless beacon 130 does not need to be utilized to process and/or complete a check-in with merchant device 140 in all embodiments.

Once a connection is established with wireless beacon 130, user device 110 may be checked-in with merchant device 140 if user 102 has not previously been checked-in. The process may associate user 102 with wireless beacon 130 used to connect to user device 110. For example, wireless beacon 130 may previous be registered as located at or nearby a specific area within a merchant location where an item/service or type of item/service is offered for sale. Thus, merchant device 140 is informed that user 102 is viewing items/services available in that specific area. As previously discussed, in other embodiments, a check-in need not be processed and/or completed to associate user 102 with the area. Thus, other connections and data transfers to wireless beacon 130 may be sufficient to associate user 102 with the area and/or merchant location.

Once a connection is established with wireless beacon 130 by check-in application 112, check-in application 112 may be utilized to transmit and receive information from merchant device 140, for example, using wireless beacon 130. Information transmitted to merchant device 140 (or service provider server 160 where service provider server 160 provides information processing services to user 102) may include application information about an application executing in the foreground of user device 110. User 102 may set preferences and/or security clearances for what application information is transmitted to wireless beacon 130 using check-in application 112 and/or in-use application 120. Such preferences may limit the information sent to wireless beacon 130. Thus, the application information sent to wireless beacon 130 may include an application type (e.g., marketplace, merchant sales, browser, etc.), an application name or other identifier, user behavior in the application, and/or data received by the application. The application information may include such information pulled/scraped from in-use application 120. In other embodiments, check-in application 112 may further retrieve information for other application executing in the background or recently used by user 102, such as an application just exited on user device 110.

Check-in application 112 may also receive information from wireless beacon 130, merchant device 140, and/or service provider server 160. Such information may correspond to incentives, nearby shopping/sale offers (e.g., other merchants offering items of interest to user 102), or other information resulting from the processing of the application information for user device 110, as will be discussed in more detail herein. The received information may be presented to user 102 through an application interface enabling user 102 to view the information while shopping at the merchant location corresponding to wireless beacon 130/merchant device 140. User 102 may further be enabled to select information presented in the user interface to initiate a process corresponding to the information, such as activate and utilize a discount offered in the information, receive assistance from a merchant employee, review additional information or link to another merchant website, receive a map of nearby locations of similar merchants offering the same or similar items/services for sale, or other process. The information presented in check-in application 112 may also be retransmitted to another device or server, such as for redemption of a gift offer or discount, receipt of merchant web services, or other additional process.

In-use application 120 may be used, for example, to provide various application features, processes, and/or services to user 102. For example, in-use application 120 may be implemented as one or more applications that may provide an Internet browser, merchant sale services, an online shopping marketplace, item input entry and lookup, price matching, mapping services enabling user 102 to find nearby merchants, or other device application. In this regard, in-use application 120 may be utilized by user 102 while user 102 is at a merchant location corresponding to wireless beacon 130 and merchant device 140. User 102 may initiate in-use application 120 to perform one of the aforementioned actions while at a merchant location corresponding to wireless beacon 130/merchant device 140. Information about the name/type of in-use application 120 may be transmitted to wireless beacon 130. Additionally, while using in-use application 120, user 102 may perform some of the aforementioned actions with in-user application. In certain embodiments, these actions, parameters, or processes for in-use application 120 may also be transmitted to wireless beacon 130, as previously discussed.

In various embodiments, one or more features of check-in application 112 and in-use application 120 may be incorporated in the same application so as to provide their respective features in one application.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 170, or other types of applications. Other applications 114 may also include email, texting, voice and IM applications that allow a user to send and receive emails, calls, texts, and other notifications through network 170. In various embodiments, other applications 114 may include financial applications, such as banking, online payments, money transfer, or other applications associated with service provider server 160. Other applications 114 may include browser, social networking, and/or mapping applications, which may also be used in conjunction with check-in application 112 and/or in-use application 120. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 112, in-use application 120, and/or other applications 114, identifiers associated with hardware of user device 110, or other appropriate identifiers, such as identifiers used for payment/user/device authentication or identification. Identifiers in database 116 may be used by a payment/credit provider, such as service provider server 160, to associate user device 110 with a particular account maintained by the payment/credit provider. Database 116 may include user device tokens and/or encryption keys, including an encryption key of wireless beacon 130, merchant device 140, and/or service provider server 160. Database 116 may include identifying information for tokens enabling check-in application 112 to identify wireless beacon 130, merchant device 140, and/or service provider server 160 when receiving a corresponding check-in token. In various embodiments, database 116 may store information transmitted to wireless beacon 130 about in-use application 120, such as application information. Incentives, information, and/or other offers may be received by user device 110 and stored to database 116.

User device 110 includes at least one communication module 118 adapted to communicate with wireless beacon 130, merchant device 140, and/or service provider server 160. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with wireless beacon 130 using short range communications, such as Bluetooth Low Energy, LTE Direct, WiFi, radio frequency, infrared, Bluetooth, and near field communications.

Wireless beacon 130 may be maintained, for example, by a merchant corresponding to merchant device 140, such as one associated with a merchant location where wireless beacon 130 may be established. Wireless beacon 130 may be implemented using any appropriate hardware and software configured for wireless communication with user device 110, merchant device 140, and/or service provider server 160. For example, in one embodiment, wireless beacon 130 may be implemented as a dongle device including a hardware processor and a communication module, for example, connected to a device at the merchant location (e.g., merchant device 140). Wireless beacon 130 may also be implemented as a device incorporated within a personal computer (PC), a smart phone, laptop computer, and/or other types of computing devices capable of transmitting and/or receiving data, such as an IPAD® from APPLE®. Wireless beacon 130 may also act as a stand-alone device including a processor, communication module, and/or network interface component configured to communicate with user device 110, merchant device 140, and/or service provider server 160. Although a single beacon is described, a plurality of wireless beacons may be utilized at the location corresponding to user 102.

Wireless beacon 130 may be located at a physical location corresponding to merchant device 140. The physical location may correspond to a merchant location, such as a retail store. Wireless beacon 130 of FIG. 1 contains processes, procedures, and/or applications, for example, a software program, executable by a hardware processor configured to interact with user device 110, merchant device 140, and/or service provider server 160. Thus, regardless of the implementation of wireless beacon 130, as discussed above, wireless beacon 130 utilizes a check-in application 132 and a communication module 134. In other embodiments, wireless beacon 130 may include additional or different software and devices as required.

Check-in application 132 may correspond to an application for transmitting requests to establish a connection between a device (e.g., user device 110) and wireless beacon 130. Thus, wireless beacon 130 may utilize short range wireless communications of wireless beacon 130 to transmit the requests to establish a connection, including an identifier such as a Universally Unique Identifier (UUID). If user device 110 receives a request to establish the connection with wireless beacon 130 and responds with a user device identifier (potentially including the UUID and other information necessary to effectuate a check-in of user device 110), check-in application 132 may cause wireless beacon 130 to ramp up in power and create a connection between user device 110 and wireless beacon 130.

Wireless beacon 130 may transmit the request to establish the connection with wireless beacon 130 as a short range wireless communication (e.g. a BLE protocol communication) including a “wake up” process for check-in application 120 of user device 110 and/or a token for wireless beacon 130. In other embodiments, the request and/or connection may utilize near field communication, radio communication, infrared communication, Bluetooth communication, or WiFi communication. Additionally, although wireless beacon 130 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacon 130 (e.g., user device 110) and establishment of a connection for data transfers.

The request may be specific to user device 110 by including information that is specific to user 102, such as a name, identifier, or user device identifier. The information specific to user 102 may be determined from a user account of user 102 or other information previously provided to merchant device 140 and/or service provider server 160. Thus, in certain embodiments, only user device 110 will pick up and authenticate the request. After check-in application 132 receives a user device identifier from user device 110, check-in application 132 may determine user 102 is in proximity to wireless beacon 130. Wireless beacon 130 may pass the user device identifier to merchant device 140 (or service provider server 160 where service provider server 160 provides the check-in services) to complete the check-in process. As shown in FIG. 1, wireless beacon 130 may utilize communication module 134 to pass the identifier to merchant device 140, which may then pass the identifier to service provider server 160. However, in other embodiments, wireless beacon 130 may utilize a network connection of wireless beacon 130 to pass the identifier to service provider server 160 directly. Additionally, check-in application 132 may cause wireless beacon 130 to keep a communication channel open between user device 110, merchant device 140, and/or service provider server 160 for passing additional information, such as application information for user device 110 and/or incentives and offers from merchant device 140/service provider server 160.

Check-in application 132 may also be utilized to request, retrieve, and/or receive information from user device 110 about an application executing in the foreground of an operating system/device interface of user device 110 (e.g., in-use application 120). For example, once a connection is established between user device 110 and wireless beacon 130 using check-in application 112/132, check-in application 132 may pull/scrape information from user device 110 of in-use application 120 while in-use application 120 is executing. As previously discussed, the application information may include just a name/type of application for in-use application 120 or may also include user input, navigation, or other actions that user 102 takes while utilizing in-use application 120, including time spent on the application. Check-in application 132 may transmit the application information to merchant device 140 and/or service provider server 160 for processing. Once one or more incentives, offers, or other information is determined for user 102, check-in application 132 may receive the information and transmit it to user device 110. However, in other embodiments, merchant device 140 and/or service provider server 160 may provide such information to user device 110 directly.

In various embodiments, wireless beacon 130 includes at least one communication module 134 adapted to communicate with user device 110, merchant device 140, and/or service provider server 160. Communication module 134 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 134 may communicate with user device 110 and/or merchant device 140 using short range communications, such as radio frequency, infrared, Bluetooth, and near field communications.

Merchant device 140 may correspond to a device at, connected to, or utilized with a merchant location, which may provide various features to a merchant and/or merchant employee at the merchant location. Thus, merchant device 140 may be located locally to the merchant location or may also function remotely to the merchant location and interact with user device 110 over network 170. In various embodiments, merchant device 140 may also be utilized to view, process, and complete financial transactions with user device 110 for the items and/or services user 102 wishes to purchase, as well as provide incentives and/or information to user device 110 based on applications executing on user device 110. Merchant device 140 may be implemented using any appropriate hardware and software configured for wired and/or wireless communication with user device 110, wireless beacon 130, and/or service provider server 160. For example, merchant device 140 may be implemented as a personal computer (PC), a smart phone, laptop computer, wristwatch with appropriate computer hardware resources, eyeglasses with appropriate computer hardware (e.g. GOOGLE GLASS®), other type of wearable computing device, and/or other types of computing devices capable of transmitting and/or receiving data, such as an IPAD® from APPLE®. Although a merchant device is shown, the merchant device may be managed or controlled by any suitable processing device. Although only one merchant device is shown, a plurality of merchant devices may function similarly. Moreover, in various embodiments, one or more of the applications, processes, and/or features discussed below in reference to merchant device 140 may be included in service provider server 160 (e.g., beacon information processing application 150 where such services are offered to user 102 through service provider server 160).

Merchant device 140 of FIG. 1 contains a beacon information processing application 150, merchant applications 142, other applications 144, a database 146, and a communication module 148. Beacon information processing application 150, merchant applications 142, and other applications 144 may correspond to processes, procedures, and/or applications, for example, a software program, executable by a hardware processor. In other embodiments, merchant device 140 may include additional or different software as required.

Beacon info nation processing application 150 may include processes to complete a check-in with user device 110 for a merchant location corresponding to wireless beacon 130/merchant device 140 (e.g., with one or more of wireless beacon 130 established at the merchant location). Thus, beacon information processing application 150 may correspond to the merchant device side application configured to receive check-in information from user device 110 and complete the check-in. The check-in request may include log in information for a user account with the merchant corresponding merchant device 140 or an account with service provider server 160 and thus complete the check-in with user 102 by verifying the account information. For example, the check-in information may include an identifier or other account information for a user/payment account of user 102. However, in embodiments where a user account has not been previously established by user 102, beacon information processing application 150 may receive other information identifying user 102, including a user name/identifier, user device identifier, an identifier for an account with another server (e.g., service provider server 160), or other information. As previously discussed, the information provided to wireless beacon 130 does not need to be utilized to complete a check-in with merchant device 140. Thus, in other embodiments, beacon information processing application 150 may receive an identifier or other identification information for user 102/user device 110 with application information for processing.

As previously discussed, wireless beacon 130 may receive application information for an application executing in the foreground of user device 110, for example, in-use application 120. Beacon information processing application 150 may receive such application information and utilize the application information to determine interests of user 102, parameters for user 102, and/or a likelihood that user 102 is performing comparative shopping and/or price matching using in-use application 120. For example, the application information may include the name, identifier, or type of application for in-use application 120, such as a browser, shopping, marketplace, item lookup, and/or mapping application. Beacon information processing application 150 may utilize such information to determine user 102 may be looking up items/services to price match, or may be investigating nearby similar merchants. In various embodiments, wireless beacon 130 may also be located at a sub-location/area within the merchant location where a specific item/service and/or type of item/service is offered for sale (e.g., a beauty counter in a department store, a television area of an electronics store, etc.). Thus, beacon information processing application 150 may determine that user 102 is engaged comparative shopping for the items/services available in the sub-area. Thus, it may be determined that user 102 is generally interested in items/services available at the merchant location or is more specifically interested in items/services available in a sub-area of the merchant location.

As previously discussed, wireless beacon 130 may also receive information about user 102's actions taken while utilizing in-use application 120. In such embodiments, beacon information processing application 150 may further utilize such user action information for in-use application 150 to further determine interests, parameters, and likelihood of comparative shopping for user 102. Such user actions may include specific user input, such as an item name or an item identifier (e.g., a scan of a bar or QR code on the items display/box), or may also include merchant name/type lookups, map searches, pricing, item/service reviews and descriptions, or other user action information. Thus, in certain embodiments, beacon information processing application 150 may further determine a specific item or service user 102 may be interested in, a specific type of merchant user 102 may be searching for, or other information determined using user 102's action information for in-use application 120.

Once the application information for user device 110 has been processed by beacon information processing application 150 to determine an interest, parameter, or other behavioral data for user 102, beacon information processing application 150 may determine an incentive, offer, or other information to provide user 102. An incentive/offer may correspond to a discount, loyalty offer, reward, credit extension, or other benefit that user 102 may utilize at the merchant location corresponding to wireless beacon 130/merchant device 140. Other information provided to user 102 may include item/service reviews, merchant reviews, descriptions of an item/service and/or the item/service's features, employee assistance, and/or merchant maps and guidance. Beacon information processing application 150 may provide such incentives and/or information based on the interest/parameters for user 102, for example, by offering 20% off televisions or a specific television if user 102 is performing price matching while shopping televisions. Beacon information processing application 150 may provide the incentive/information to an employee as well, which may provide direct assistance to user 102.

Beacon information processing application 150 may further determine an overall likelihood that users engage in comparative shopping and/or price matching when shopping at the merchant location and/or for specific items/services at the merchant location. For example, if most or all users open a browser application or marketplace application while shopping at the merchant location, as determined using wireless beacon 130, beacon information processing application 150 may determine that most or all users perform comparative shopping/price matching at the merchant location. In other embodiments, beacon information processing application 150 may determine comparative shopping is performed for certain items more often than other items. In such embodiments, wireless beacon 130 may be located at a sub-area where a specific item is sold. Thus, when wireless beacon 130 receives information that 50% of users in the sub-area utilize in-use application 150 in the sub-area and/or perform item lookup and price matching using in-use application 150, beacon information processing application 150 may determine user 102 is likely to perform comparative shopping for the items/services available in the sub-area. However, in another sub-area, another wireless beacon may record that only 5% of users utilize in-use application 150 in the sub-area. Thus, for the second sub-area, beacon information processing application 150 may determine that user 102 is not likely to perform comparative shopping and price matching in the second sub-area. The data may also be utilized to determine how often a particular user or group of users actually makes a purchase based on activity of in-use application 120. For example, a merchant may not provide an incentive if user 102 historically only buys after much analysis and the user has just started searching for the particular item, while information about another user may indicate the user is ready to make a purchase right away.

Utilizing information about the likelihood that users will perform comparative shopping and price matching at the merchant location and/or for specific items/service available at the merchant location, beacon information processing application 150 may guide merchant application 142 in sale pricing for items/services available at the merchant location. The sale pricing may correspond to a purchase amount for the items/service available at the merchant location, and may be guided by competitors pricing for the same and/or similar items/services. For example, if a user is likely to perform comparative pricing at a merchant location with a competitor X, then beacon information processing application 150 may determine that the prices at the merchant location should be competitive with the competitor X's prices. In various embodiments where the determination of the comparative shopping is specific to certain items/services and/or types of items/service, beacon information processing application 150 may determine which items/services should have prices competitive with the competitor's prices. In such embodiments, beacon information processing application 150 may determine a competitor Y is often accessed for televisions based on application information, thus television pricing should be competitive with competitor Y, while users do no comparative shop for Internet routers, thus, there is less of a priority to adjust the pricing for Internet routers.

Merchant applications 142 may provide information for available items and/or services to user 102, complete purchases of items and/or services by user 102, and generate receipts and transaction histories for user 102. Merchant applications 142 may correspond to one or more applications configured to process and/or complete transactions for items and/or services sold by the merchant corresponding to the merchant location/merchant device 140 to user 102, generate receipts and transaction histories for the item(s)/service(s), and/or provide loyalty account services and benefits to user 102. Merchant applications 142 may therefore provide a convenient interface to permit the merchant and/or a merchant employee to view selected item/service information and complete a transaction for the items/services (e.g., receive payment for the items/services). Once the transaction is approved, merchant applications 142 may be utilized to request and process a payment for the items/service through physical payment instruments, such as cash and/or payment cards from user 102, or payment accounts with a payment provider. Thus, merchant applications 142 may also be utilized to run payment cards, complete cash transactions, and/or otherwise complete payment for the order. Once payment for the order is complete, merchant applications 142 may be configured to generate a receipt and create, update, and/or process a transaction history for user 102. Such transaction histories may be provided to user device 110.

In various embodiments, merchant applications 142 may include inventory processing and availability information applications configured to access and/or determine inventory level or availability for items and/or services offered by the merchant corresponding to merchant device 140. For example, merchant applications 142 may access information from database 146 or another source having an inventory level for an item sold by the merchant. The inventory level or availability information may further include pricing information for the available items/service. Beacon information processing application 150 may be utilized to guide pricing information for the available items/services, as previously discussed.

Additionally, merchant applications 142 may be utilized to establish and maintain a loyalty account for user 102, determine incentives and other benefits for user 102, and/or request employee assistance for user 102. Loyalty account information may include benefits and/or rewards for user 102 based on user 102's past transactions with the merchant corresponding to the merchant device 140. The loyalty account and/or transaction histories may offer user 102 additional benefits when purchasing an item, such as a 2 for 1 sale, 50% off price, etc. In other embodiments, merchant applications 142 may also include discount offer applications that may generate and provide discount offers to user 102. Such offers may be determined using interests/information determined by beacon information processing application 150 from application information received from wireless beacon 130. The loyalty accounts, discounts, offers, and other incentives may also be determined using sale/offer information for the merchant, and may be provided to user 102. Moreover, merchant applications 142 may further determine if employee assistance is required for user 102, contact a merchant employee, and/or provide information regarding the employee assistance to user device 110 (e.g., an employee name, location, specialty, etc.).

Merchant device 140 includes other applications 144 as may be desired in particular embodiments to provide features to merchant device 140. For example, other applications 144 may include security applications for implementing client-side security features, programmatic client applications for interfacing with appropriate application programming interfaces (APIs) over network 170, or other types of applications. In various embodiments, other applications 144 may include financial applications, such as banking, online payments, money transfer, or other applications associated with service provider server 160. Other applications 144 may contain other software programs, executable by a processor, including a graphical user interface (GUI) configured to provide an interface to the user.

Merchant device 140 may further include database 146 which may include, for example, identifiers such as operating system registry entries, cookies associated with beacon information processing application 150, merchant applications 142, and/or other applications 144, identifiers associated with hardware of merchant device 140, or other appropriate identifiers, such as identifiers used for payment/user/device authentication or identification. In one embodiment, identifiers in database 146 may be used by service provider server 160 to associate merchant device 140 with a particular account maintained by service provider server 160. Database 146 may also store user 102's information, including check-in information, an identifier, etc., for user 102. Application information retrieved by wireless beacon 130 may be stored to database 146 for use in processing to determine interests, parameters, and a likelihood of comparative shopping for user 102. Moreover, incentives, discounts, offers, benefits, loyalty accounts, and/or other information presentable to user 102 may be stored to database 146.

Merchant device 140 includes at least one communication module 148 adapted to communicate with user device 110, wireless beacon 130, and/or service provider server 160. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 148 may communicate directly with wireless beacon 130 using short range communications, such as Bluetooth Low Energy, LTE Direct, radio frequency, infrared, Bluetooth, and near field communications.

Service provider server 160 may be maintained, for example, by an online service provider, which may provide various services to user 102. In various embodiments, service provider server 160 may provide service tied to in-use application 120, including web search services, marketplaces, merchant sales, item lookup, and/or other services that may be accessed and utilized using in-use application 120. In other embodiments, service provider server 160 may provide other services to user 102, such as beacon information processing services that may provide information to user 102 based on application information received by wireless beacon 160. In this regard, service provider server may be provided by an online merchant marketplace, such as EBAY®, Inc. of San Jose, Calif., USA. Service provider server 160 may also correspond to another online service provider that may provide other services to user 102, such as a payment provider. In this regard, service provider server 160 may be provided by PAYPAL®, Inc. of San Jose, Calif., USA. Service provider server 160 includes one or more processing applications which may be configured to interact with user device 110, wireless beacon 130, and/or merchant device 140 to facilitate payment for a transaction. Moreover, in various embodiments, one or more of the applications, processes, and/or features discussed below in reference to service provider server 160 may be included in merchant device 140, and vice versa.

Service provider server 160 of FIG. 1 includes a service provider application 162, other applications 164, a database 166, and a network interface component 168. Service provider application 162 and other applications 164 may correspond to processes, procedures, and/or applications, for example, a software program, executable by a hardware processor. In other embodiments, service provider server 160 may include additional or different software as required, such as a beacon information processing application as discussed in reference to merchant device 140, where such processes and features are instead provided by service provider server 160.

Service provider application 162 may be configured to receive information from and/or transmit information to user device 110 and/or merchant device 140 corresponding to one or more services offered by service provider server 160. In this regard, service provider application 162 may correspond to an application offering back end processing features for in-use application 120, such as a search engine application, a marketplace and/or merchant sales application offering an interface and online marketplace for the sale of item/services, an item/service lookup or search application that may receive item/service information through user input, images, and/or scans of item/service displayable information and perform searches using such information, and/or other application used in conjunction with in-use application 120. In this regard, service provider application 162 may provide search features for available items/services matching user 102's input and provide user 102 with the same or similar items/services, pricing for the items/services, and/or descriptions and other information for the items/services. In various embodiments, service provider application 162 may further allow for purchase of the items/services and/or search of nearby available merchants having the items/services, the merchant's location, and/or the merchant's pricing for the items/services. Thus, in various embodiments, service provider application 162 may further provide payment processing applications and features.

In various embodiments, service provider server 160 may also correspond to another service provider that may offer similar features to beacon information processing application 150, including processing of application information to determine user interests and/or parameters and present user 102 with incentives, item/service offer information, or other offers. In such embodiments, service provider application 162 may offer the same or similar features to beacon information processing application 150 but may not limit such incentives and/or offers to a merchant corresponding to merchant device 140. In this regard, service provider application 162 may present other nearby merchants to the merchant location corresponding to merchant device 140 that sell the same or similar items/services to the merchant corresponding to merchant device 140. Service provider application 162 may present the nearby similar merchants after processing the application information. Service provider application 162 may also receive information about a sub-area of the merchant location for wireless beacon 130 that may be utilized to determine the item/service and/or type of item/service of interest to user 102 with more specificity. Moreover, service provider application 162 may present user 102 with pricing, maps, store hours, and/or other assistance for the nearby merchant.

In various embodiments, service provider server 160 includes other applications 164 as may be desired in particular embodiments to provide features to service provider server 160. For example, other applications 164 may include security applications for implementing server-side security features, programmatic server applications for interfacing with appropriate application programming interfaces (APIs) over network 170, or other types of applications. Other applications 164 may contain software programs, executable by a processor, including a graphical user interface (GUI), configured to provide an interface to a user.

Additionally, service provider server 160 includes database 166. In various embodiments where service provider server 160 provide payment services, an online marketplace, or other services requiring a user account, user 102 and/or the merchant corresponding to the merchant device 140 may establish one or more accounts with service provider server 160. User accounts in database 166 may include merchant/user information, such as name, address, birthdate, payment/funding information, additional user financial information, and/or other desired user data. User 102 and/or the merchant may link to their respective accounts through a user, merchant, and/or device identifier. In other embodiments, user 102 and/or the merchant may not have previously established an account and may provide other financial and/or personal information to service provider server 160. Database 166 may further include additional information received from user device 110 and/or merchant device 140, such as user input corresponding to in-use application 120, application information for user device 110, incentives, offers, item/service information, and/or merchant information as required by service provider application 162.

In various embodiments, service provider server 160 includes at least one network interface component 168 adapted to communicate user device 110, wireless beacon 130, and/or merchant device 140 over network 170. In various embodiments, network interface component 168 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 170 may be implemented as a single network or a combination of multiple networks. For example, in various embodiments, network 170 may include the Internet or one or more intranets, landline networks, wireless networks, and/or other appropriate types of networks. Thus, network 170 may correspond to small scale communication networks, such as a private or local area network, or a larger scale network, such as a wide area network or the Internet, accessible by the various components of system 100.

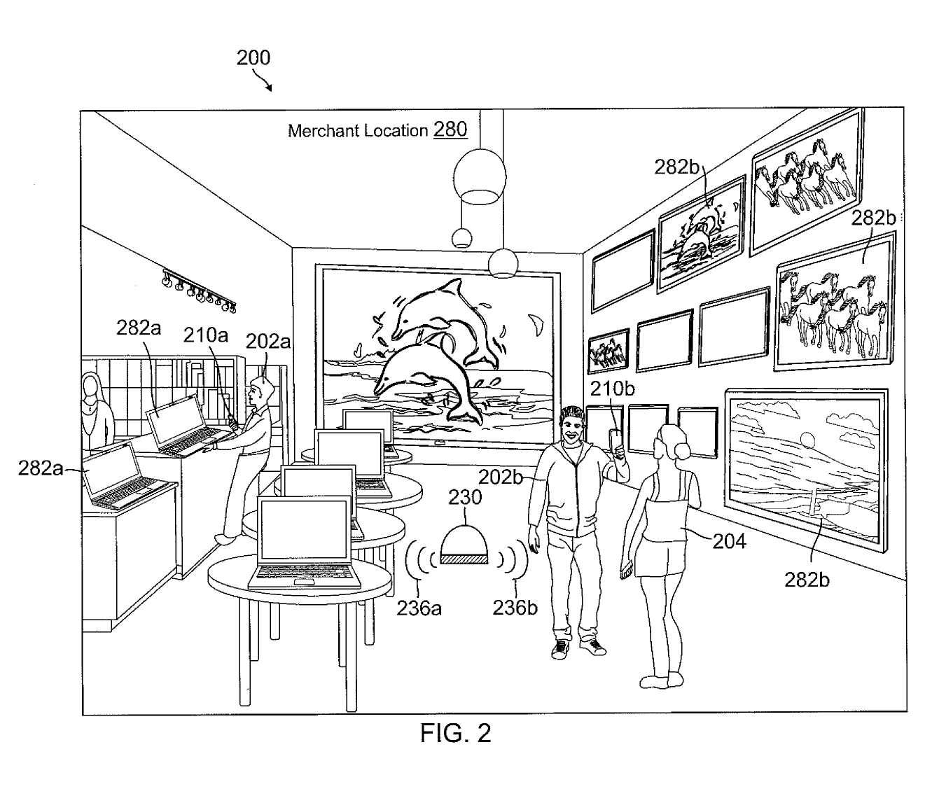

FIG. 2 is an exemplary environment displaying a wireless beacon reporting applications executing the in foreground of user devices for users at a merchant location, according to an embodiment. Environment 200 of FIG. 2 includes a user 202a having a user device 210a and a user 202b having a user device 210b both corresponding generally to user 102 and user device 110, respectively, of FIG. 1. Additionally, environment 200 includes a wireless beacon 230 corresponding to wireless beacon 130 of FIG. 1.

Environment 200 includes a merchant location 280 where one or more users may visit to shop for and/or purchase items, such as items 282a or item 282b. As shown at merchant location 280, items 282a may correspond to a plurality of laptop computers, while item 282b may correspond to a big screen television. In environment 200, user 202a visits merchant location 280 with user device 210a to shop for items 282a. While viewing items 282a, user 202a may utilize user device 210a to access an application that may assist user 202a in determining whether user 202a would like to purchase items 282a. For example, user 202a may execute an application that enables user device 210a to capture images related to items 282a, such as bar/QR codes, and perform an Internet search for items 282a, including prices from competitors to merchant location 280 for items 282a. In other embodiments, user 202a may access an online marketplace using user device 210a that may include the same or similar items to items 282a with pricing for such items. Thus, user 202a may utilize user device 210a to perform comparative shopping and price matching for items 282a while at merchant location 280.

Wireless beacon 230 may connect with user device 210a through connection signal 236a and receive information about the applications executing on user device 210a while user 202a is shopping for items 282a. Thus, if user 202a is performing comparative shopping, wireless beacon 230 may receive such information through connection signal 236a. Wireless beacon may be located within an “electronics” section of merchant location 280, enabling an entity to determine with more specificity that user 202a is using an application to search for electronics. Thus, an entity processing the aforementioned information may determine that user 202a is interested in electronics. If additional information about user 202a's actions using the application on user device 210a is sent to wireless beacon 230, the entity may further determine that user 202a is shopping for items 282a. Thus, the entity may provide price matching to competitors, discounts, or other incentives to attempt to get user 202a to purchase one or more of items 282a while user 202 is shopping at merchant location 280.

Similarly, user 202b is viewing item 282b while utilizing user device 210b to perform some comparative shopping and/or price matching for item 282b. Wireless beacon 230 may further connect to user device 210b using connection signal 236b. Using connection signal 236b, the entity receiving application information for applications executing on user device 210b may determine that user 202b may require assistance to help user 202b select item 282b or provide incentives to purchase item 282b while at merchant location 280. Such assistance and incentives may be provided by a merchant employee 204, who may provide assistance to user 202b as well as incentives (e.g., a no cash down offer for item 282b). Merchant employee may be provided with the location and identifying information for user 202b using the information retrieved by wireless beacon 230 using connection signal 236b.

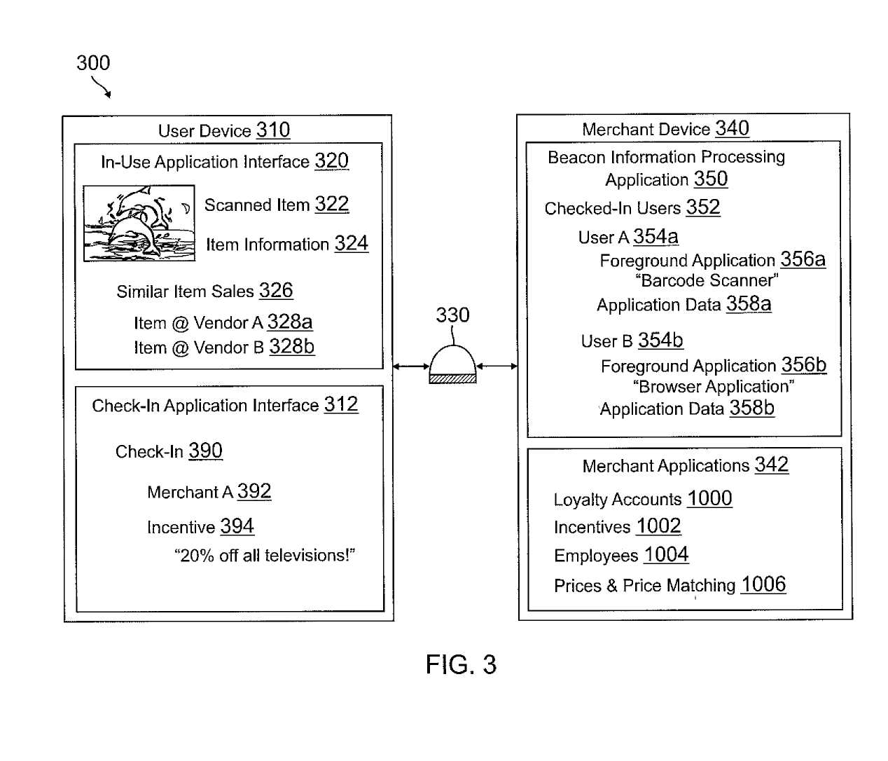

FIG. 3 is an exemplary system environment showing a user interface of a user device and a merchant device after receiving information of application executing on a user device from a wireless beacon, according to an embodiment. Environment 300 of FIG. 3 includes a user device 310, a wireless beacons 330, and a merchant device 340 corresponding generally to user device 110, wireless beacon 130, and merchant device 140, respectively, of FIG. 1.

User device 310 displays an in-use application interface 320 and a check-in application interface 312 corresponding generally to the processes and features described in reference to in-use application 120 and check-in application 112, respectively, of FIG. 1. In-use application interface 320 includes a scanned item 322 having an image, item information 324, and similar item sales 326. In environment 300, in-use application interface 320 may correspond to an application where a user may scan or capture an image of a device bar/QR code for use in looking up that item and viewing similar sales of the item available with other merchants and/or marketplaces. Thus, the user of user device 310 may utilize in-use application 320 while shopping for items at a merchant location, such as user 202a/202b of FIG. 2. In this regard, after the user of user device 310 captures an image of the item for scanned item 322, item information 324 may populate or be entered by the user to search for scanned item 322 with more specificity. The user may then perform comparative shopping/price matching for scanned item 322 and view information under similar item sales 326 in order to decide whether the user would like to purchase scanned item 322 or may find a better offer under similar item sales 326. Thus, an item at vendor A 328a and an item at vendor B 328b may display information from two other competitors of the same or similar scanned item 322. The user may then utilize in-use application interface 320 to be more informed about offers available for scanned item 322.

Wireless beacon 330 may communicate information to merchant device 340 about the user's use of in-use application 320. As previously discussed, such application information may correspond to the name/type of application corresponding to in-use application 320 and/or information in the application, such as scanned item 322 and/or similar item sales 326. Merchant device 340 includes a beacon information processing application 350 and merchant applications 342 corresponding generally to the processes and features described in reference to beacon information processing application 150 and merchant applications 142, respectively, of FIG. 1. As previously discussed, beacon information processing application 350 may be utilized to determine the user of user device 310's interests and/or parameters from the received application information. Thus, beacon information processing application 350 includes checked-in users 352 having a user A 354a and a user B 354b. User A 354a includes a foreground application 356a and application data 358a. Similarly, user B 354b includes a foreground application 356b and application data 358b. Foreground applications 356a/356b includes information about the name/type of application executing in the foreground of a user device. Thus, in this case, foreground application 356a may correspond to user device 310 and displays “barcode scanner.” Similarly, foreground application 356b may correspond to another user device and displays “browser application.” Application data 358a/358b may include additional application information, such as user actions, input, and/or navigations within the application, as previously discussed.

Beacon processing application 350 may utilize the information under user A 354a and user B 354b to determine interests/parameters for user A and user B. Additionally, beacon processing application 350 may utilize merchant applications 342 in order to determine incentives and/or information to offer to user A and user B. Merchant applications 342 include loyalty accounts 1000, incentives 1002, employees 1004, and prices and price matching 1006. Loyalty accounts 1000 may correspond to one or more loyalty accounts for user A and user B and may include benefits that may be extended to user A and user B, such as preferred/loyal customer benefits. Incentives 1002 include other such incentives that may be extended to user A and user B, and may be item/service specific (e.g., specific to scanned item 322) or general for the merchant. Incentives 1002 may therefore include general or specific discounts, credit extensions, coupons, payment plans, etc. Employees 1004 may be utilized to determine which employees may assist user A and user B, their specialties, their work schedules, their location within a merchant location, their availability, and/or their contact information in order to send the employee to user A/user a Additionally, prices and price matching 1006 may include information for item/service pricing and policies regarding price matching, such as matching the lowest competitor, only providing a 5% price reduction, matching 90% of the competitors discounted price, etc.

Once merchant device 340 has processed the application information for user A and user B and determined one or more incentives and/or information to provide to user A and user B, the incentives/information may be transmitted to their respective user devices. Thus, user device 310 may receive user A's incentives/information and display such information to the user of user device 310 through check-in application interface 312. Check-in application interface 312 displays a check-in 390 having a merchant A 392 and an incentive 394. Check-in 390 may display information enabling the user to determine that the user and user device 310 having been checked-in to a merchant and in-use application interface 320 may be monitored. Thus, check-in 390 may also be utilized to perform a check-out with merchant A 392, such as through initiating a process by selecting merchant A 392. Moreover, check-in 390 may display the incentives received for merchant A 392, such as under incentives 394. Thus, incentives 394 display “20% off all televisions!” In this way, the merchant corresponding to merchant device 310 may attempt to retain the user of user device 310 as a customer even while the user attempts to price match scanned item 322 through in-use application interface 320.

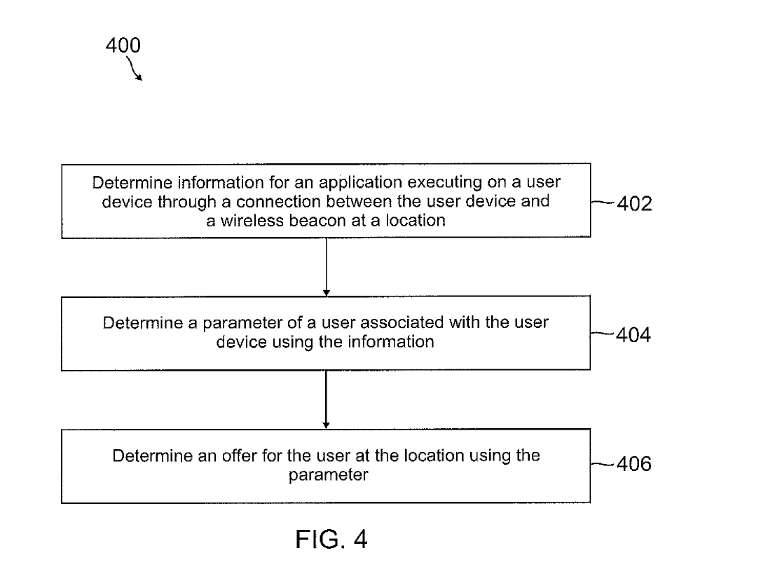

FIG. 4 is a flowchart of an exemplary process for wireless beacons for reporting of applications in the foreground of a user device interface, according to an embodiment. Note that one or more steps, processes, and methods described herein may be omitted, performed in a different sequence, or combined as desired or appropriate.

At step 402, information for an application executing on a user device is determined through a connection between the user device and a wireless beacon at a location. The information may correspond to application information, such as a name/type of an application executing in the foreground of the user device operating system/display interface. The connection may use one of near field communication, radio communication, infrared communication, Bluetooth communication, Bluetooth Low Energy (BLE) communication, WiFi communication, and LTE Direct communication. The may comprise one of a browser application, an item pricing application, a merchant sales application, and a marketplace application.

A parameter of a user associated with the user device is determined using the information. The parameter may comprise an interest of the user, such as an item of interest to the user. An action for the user may also be received, wherein the parameter and/or interest of the user is further determined using the action. An action may correspond to an action by the user in the application, such as input, navigation, received information, etc. Thus, the action may comprise at least one of an image scan or input of item information, an item lookup, an item pricing lookup, and an item review lookup. The parameter may also comprise comparative shopping behavior of the user with a competitor.

At step 406, an offer is determined for the user at the location using the parameter. The offer may correspond to a discount, provided information, incentive, or other assistance offer. The offer may be communicated to the user as well as a salesperson or employee at the location. The offer may correspond to a discount or sale offer the salesperson may be able to assist the user with redeeming. Before determining the offer, an item of interest may be determined for the user using the parameter for the user and an area within the location for the wireless beacon. Thus, the area for the user may be determined using the area for the wireless beacon within the location and the connection between the user device and the wireless beacon. Thus, the offer may correspond to a discount for the item of interest to the user and/or an offer of a similar item for sale for the user. In various embodiments, the offer may be determined by a service provider that may determine similar items/services available from nearby merchants. The offer may also be determined using a sale price for a competitor for an item of interest previously determined.

In various embodiments, application information for a plurality of applications each operating in the foreground of an interface for a plurality of user devices may be accessed using a connection between each of the plurality of user devices and at least one wireless beacon within an item area at a merchant location. Thus, at least one item corresponding to the item area at the merchant location may be determined or accessed and a likelihood of comparative shopping for users associated with the plurality of user devices may be determined using the application information and the at least one item. Using this information a sale price for the at least one item may be determined using the likelihood of comparative shopping and the at least one item. Additionally, a competitor price for the at least one item may be accessed, wherein the sale price is further determined using the competitor price. In further embodiments, the sale price may be decreased when the likelihood of comparative shopping is above a threshold and increased or maintained the same when the likelihood of comparative shopping is below the threshold.

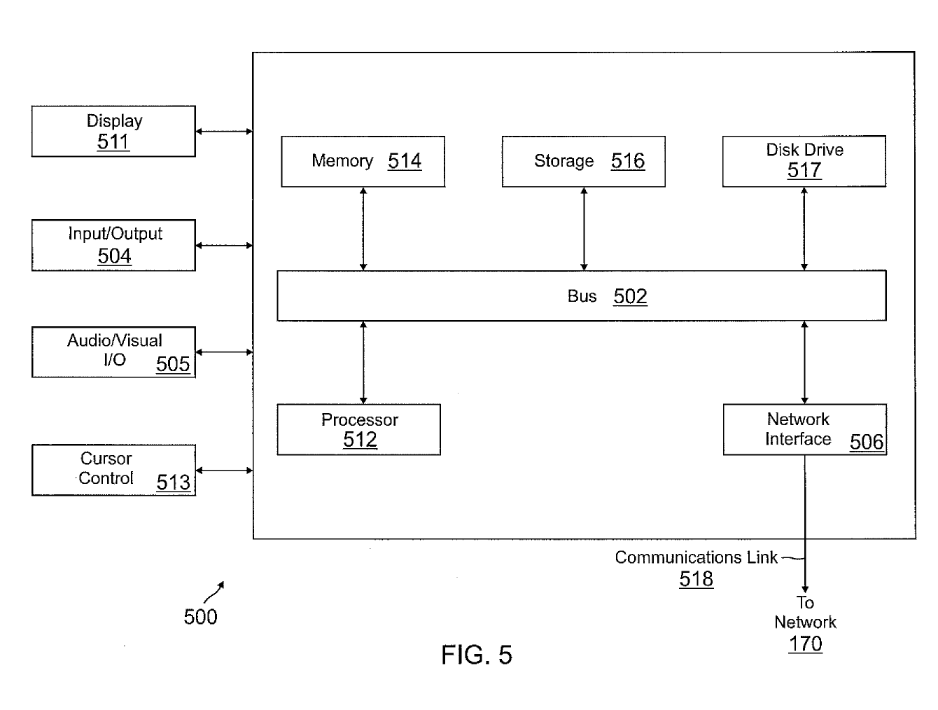

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 170. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing one or more incentives for a location; and
one or more hardware processors in communication with the non-transitory memory and configured to:
receive an indication of an application operating on a user device using a connection between the user device and a wireless beacon at the location;
determine an interest of a user corresponding to the user device using the indication; and
determine an incentive to offer the user for the location using the interest.

2. The system of claim 1, wherein the connection uses one of near field communication, radio communication, infrared communication, Bluetooth communication, Bluetooth Low Energy (BLE) communication, WiFi communication, and LTE Direct communication.

3. The system of claim 1, wherein the one or more hardware processor are further configured to:
communicate the incentive to the user device for display to the user.

4. The system of claim 3, wherein the one or more hardware processors are further configured to:
communicate the incentive to a salesperson device for a salesperson at the location, wherein the incentive comprises at least one of a discount offer and an available sale offer.

5. The system of claim 1, wherein the application operates in the foreground of a display interface for the user device.

6. The system of claim 5, wherein prior to the one or more hardware processors determining the interest, the one or more hardware processors are further configured to:
receive an action by the user using the application,
wherein the interest is further determined using the action.

7. The system of claim 6, wherein the action comprises at least one of an image scan or input of item information, an item lookup, an item pricing lookup, and an item review lookup.

8. The system of claim 7, wherein prior to the one or more hardware processors determining the incentive to offer the user, the one or more hardware processors are further configured to:
determine an item of interest to the user using the interest and an area for the user at the location.

9. The system of claim 8, wherein the incentive comprises a discount offer for at least one of the item of interest and a similar item to the item of interest.

10. The system of claim 8, wherein the area of the user at the location is determined using the connection between the user device and the wireless beacon, and wherein the wireless beacon is located at or nearby the area.

11. A method comprising:
access application information for an application executing in the foreground of an interface for a user device using a connection between the user device and a first wireless beacon at a merchant location;
determine a parameter for a user associated with the user device using the application information;
determine information to provide the user using the parameter; and
communicate the information to the user.

12. The method of claim 11, wherein the parameter comprises comparative shopping actions by the user for at least one item available at the merchant location.

13. The method of claim 12 further comprising:
receiving a price for the at least one item from a competitor based on the comparative shopping actions.

14. The method of claim 13, wherein the information comprises discounts and sales for the merchant location that match or are lower than the price for the at least one item from the competitor.

15. The method of claim 11, wherein the application comprises one of a browser application, an item pricing application, a merchant sales application, and a marketplace application.

16. The method of claim 11 further comprising:
determining a location of the user at the merchant location using the connection between the user device and the wireless beacon,
wherein the parameter is further determined using the location, and wherein the parameter comprises an item of interest to the user.

17. The method of claim 11, wherein the information comprises sales of the item of interest with at least one other merchant nearby the merchant location.

18. A non-transitory computer-readable medium comprising instructions which, in response to execution by a computer system, cause the computer system to perform a method comprising:
accessing application information for a plurality of applications each operating in the foreground of an interface for a plurality of user devices using a connection between each of the plurality of user devices and at least one wireless beacon within an item area at a merchant location;
accessing at least one item corresponding to the item area at the merchant location;
determining a likelihood of comparative shopping for users associated with the plurality of user devices using the application information and the at least one item;
determining a sale price for the at least one item using the likelihood of comparative shopping and the at least one item.

19. The non-transitory computer-readable medium of claim 18, wherein prior to determining the sale price, the method further comprises:
accessing a competitor price for the at least one item,
wherein the sale price is further determined using the competitor price.

20. The non-transitory computer-readable medium of claim 19, wherein the sale price is decreased when the likelihood of comparative shopping is above a threshold, and wherein the sale price is increased or maintained the same when the likelihood of comparative shopping is below the threshold.
